(19) United States
(12) Patent Application Publication
(10) Pub. No.: US 2006/0231198 A1
(43) Pub. Date: Oct. 19, 2006

(54) Manufacturing process: how to construct constraining core material into printed wiring board

(76) Inventor: Kalu K. Vasoya, Huntington Beach, CA (US)

Correspondence Address: CHRISTIE, PARKER & HALE, LLP, PO BOX 7068, PASADENA, CA, 91109-7068, US

(21) Appl. No.: 11/376,806

(22) Filed: Mar. 15, 2006

Related U.S. Application Data
(60) Provisional application No. 60/662,162, filed on Mar. 15, 2005.
(60) Provisional application No. 60/763,697, filed on Jan. 30, 2006.

(51) Int. Cl. B32B 37/00

(52) U.S. Cl. 156/256

(57) ABSTRACT

Processes for manufacturing printed wiring boards including electrically conductive constraining cores are disclosed. Several of the processes enable precise alignment of tooling holes used by tools to perform processes with respect to various panels and subassemblies used to form finished printed wiring boards. Modifications to Gerber files that can increase manufacturing yield and provide the ability to detect faulty printed wiring boards in a panelized array of printed wiring boards are also discussed. One embodiment of the invention includes aligning the weave of a woven panel of electrically conductive material relative to a tool surface using at least a pair of references and forming tooling holes in the panel of electrically conductive material.

### CROSS-REFERENCE TO RELATED APPLICATION(S)

The present invention claims priority to U.S. Provisional Patent Application Ser. No. 60/662,162 filed Mar. 15, 2005 and U.S. Provisional Patent Application Ser. No. 60/763,697 filed Jan. 30, 2006, the disclosure of both applications is disclosed herein by reference in its entirety.

### FIELD OF THE INVENTION

The present invention relates generally to the manufacture of printed wiring boards and more specifically relates to the production of printed wiring boards that include electrically conductive constraining cores.

### BACKGROUND

An electrically conductive constraining core, in any of a variety of forms, can be used as a layer within a printed wiring board. The electrically conductive constraining core can be used either as a purely structural layer (i.e., a layer that does not form part of the circuit of the printed wiring board) or as a functional layer (i.e., a layer that forms part of the circuit). U.S. Pat. No. 6,869,664 to Vasoya et al. describes the use of electrically conductive constraining cores as power, ground and/or split power/ground planes in printed wiring boards. The disclosure of U.S. Pat. No. 6,869,664 to Vasoya et al. is hereby incorporated by reference in its entirety.

A common material used in the construction of an electrically conductive constraining core is woven carbon fiber (usually with a balanced weave) that is impregnated with resin and clad on one or more sides with metal. However, a variety of other materials can be used in the construction of electrically conductive constraining cores. Many electrically conductive constraining cores include a conductive laminate that can be clad or unclad. The laminate can be a substrate impregnated in resin. Often the substrate is a fibrous material such as carbon, graphite fibers such as CN-80-3k, CN-60, CN-50, YS-90 manufactured by Nippon Graphite Fiber of Japan, K13B12, K13C1U, K63D2U manufactured by Mitsubishi Chemical Inc. Japan, T300-3k, T300-1k manufactured by Cytec carbon fibers LLC of Greenville, S.C. Often the electrically conductivity of the fibers is increased by coating the fibrous material in metal prior to impregnation with resin. Examples of metal coated fibers includes carbon, graphite, E-glass, S-glass, Aramid, Kevlar, quartz or any combinations of these fibers. Often the fibrous material can be continuous carbon fiber. Alternatively, the fibrous material can be discontinuous carbon fiber. Discontinuous fibers such as spin broken fibers (X0219) manufactured by Toho Carbon Fibers Inc, Rockwood, Tenn., USA. Fibrous material can be woven or non-woven. Non-woven material can be in a form of the Unitape or a mat. Carbon mat such as grade number 8000040 and 8000047, 2 oz and 3 oz respectively manufactured by Advanced Fiber NonWovens, East Walpole, Mass. Electrically conductive constraining cores are known that are constructed from PAN based carbon fiber, Pitch based carbon fiber or a combination of both fibers.

Electrically conductive constraining cores can also be constructed using non-fibrous materials. For example, an electrically conductive constraining core can be constructed from a solid carbon plate. Solid carbon plates useful as electrically conductive constraining cores can be made using compressed carbon or graphite powder. Another approach is to make a solid carbon plate using carbon flakes or chopped carbon fiber with a thermo plastic or thermo setting binder.

Another useful material for use in the construction of electrically conductive constraining cores is C—SiC (Carbon-Silicon Carbide), which is manufactured by Starfire Systems Inc. located in Malta, N.Y.

A variety of resins can be used in the construction of electrically conductive constraining cores such as Epoxy, Bismaleimide Triazine epoxy (BT), Bismaleimide (BMI), Cyanate Ester, Polyimide, Phenolic or a combination of some of the above. In many instances, the resin can have filler like pyrolytic carbon powder, carbon powder, carbon particles, diamond powder, boron nitride, aluminum oxide, ceramic particles, and phenolic particles to improve properties.

The electrical conductivity of an electrically conductive constraining core varies depending upon its construction. In many instances the substrate drives the electrical properties of the electrically conductive constraining core. For example, graphite fibers with toughened epoxy. In other instances, resin can drive electrical property of the conductive layer. For example, glass fibers impregnated with toughened epoxy resin that has pyrolytic carbon powder as a filler material.

The selection of the constraining core material typically depends on the benefits required at the final product level such as heat transfer rate, coefficient of thermal expansion, stiffness and combinations of these. In a broad sense, any combination of material and resin can be used in the construction of an electrically conductive constraining core that results in a laminate layer having a dielectric constant that is greater than 6.0 at 1 MHz.

Plated vias, also referred to as through holes, are commonly used to create electrical connections between the functional layers of a printed wiring board. When an electrically conductive constraining core is incorporated into a printed wiring board design, care must be taken to ensure that plated vias do not create unwanted electrical connections with the electrically conductive constraining core. In many printed wiring board designs, unwanted electrical connections are prevented using resin filled clearance holes. Resin filled clearance holes are holes that are drilled through the electrically conductive constraining cores and then filled with a dielectric resin. When a plated via possessing a diameter less than the diameter of a resin filled clearance hole is drilled through the center of the resin filled clearance hole, the resin surrounding the plated via electrically isolates the lining of the via from the electrically conductive constraining core. During manufacture, the extent of tolerable misalignment between the centers of the resin filled clearance holes and the plated vias is determined largely by the difference in diameter between the resin filled clearance holes and the plated vias. In situations where misalignment results in a portion of the plated via contacting the electrically conductive constraining core, then an unintended electrical connection between the lining of the via and the electrically conductive constraining core results.

### SUMMARY OF THE INVENTION

Processes for manufacturing printed wiring boards including electrically conductive constraining cores are disclosed. Processes in accordance with the present invention enable precise alignment of tooling holes used by tools to perform processes with respect to various panels and subassemblies used to form finished printed wiring boards. Modifications to Gerber files in accordance with embodiments of the present invention are also disclosed that can increase manufacturing yield and provide the ability to detect faulty printed wiring boards in a panelized array of printed wiring boards.

One embodiment of the present invention includes aligning the weave of a woven panel of electrically conductive material relative to a tool surface using at least a pair of references and forming tooling holes in the panel of electrically conductive material.

In a further embodiment, the pair of references include at least two mounting pins positioned along a first line, at least two mounting pins positioned along a second line and the first and second lines intersect at a right angle.

In another embodiment, the pair of references include a first reference edge, a second reference edge and the first and second reference edges meet at a right angle.

In a yet further embodiment, the tooling holes are formed using a drill.

In yet another embodiment, the tooling holes are formed using a punch.

A still further embodiment of the invention includes forming a first set of tooling holes in a panel of electrically conductive material, drilling clearance holes having a first diameter in the electrically conductive panel, forming a stack of panels by aligning the panel of electrically conductive material with other layers of material using the first set of tooling holes and laminating the stack of panels.

Still another embodiment also includes drilling through holes having a second diameter less than the first diameter through the laminated stack.

A further embodiment again also includes using the first set of tooling holes as a reference to determine the locations in which to drill the through holes.

Another embodiment again also includes drilling at least one reference hole, using an optical vision system to locate the at least one reference hole and drilling a second set of tooling holes in predetermined locations relative to the at least one reference hole.

A further additional embodiment also includes drilling at least one reference hole, using an optical vision system to locate the at least one reference hole and punching a second set of tooling holes in predetermined locations relative to the at least one reference hole.

Another additional embodiment also includes aligning artwork against the electrically conductive panel, screening photoresist over the artwork and etching the electrically conductive panel.

In a still yet further embodiment, aligning the artwork includes punching holes corresponding to the first set of tooling holes in the artwork and aligning the artwork and the electrically conductive panel using the first set of tooling holes.

Still yet another embodiment includes forming a first set of tooling holes in a panel of electrically conductive material, drilling clearance holes having a first diameter in the electrically conductive panel, forming a second set of tooling holes through the panel of electrically conductive material, forming a stack of panels by aligning the panel of electrically conductive material with other layers of material using the second set of tooling holes and laminating the stack of panels.

In a yet further embodiment again, the forming of a second set of tooling holes further includes using the first set of tooling holes as a reference to locate predetermined locations and drilling the second set of tooling holes at the predetermined locations.

In yet another embodiment again, forming of a second set of tooling holes further includes using the first set of holes as a reference to locate at least one predetermined location, drilling a reference hole in the at least one predetermined location, using an optical vision system to locate the reference hole and using the optical vision system to punch the second set of tooling holes in predetermined locations relative to the reference hole.

A yet further additional embodiment also includes drilling through holes having a second diameter less than the first diameter through the laminated stack.

Still yet another additional embodiment also includes using either the first or the second set of tooling holes as a reference to determine the locations in which to drill the through holes.

A still further embodiment again also includes drilling at least one reference hole, using an optical vision system to locate the at least one reference hole and drilling a second set of tooling holes in predetermined locations relative to the at least one reference hole.

Still another embodiment again also includes drilling at least one reference hole, using an optical vision system to locate the at least one reference hole and punching a second set of tooling holes in predetermined locations relative to the at least one reference hole.

A still further additional embodiment also includes aligning artwork against the electrically conductive panel, screening photoresist over the artwork and etching the electrically conductive panel.

In still another additional embodiment, aligning the artwork includes punching holes corresponding to the first set of tooling holes in the artwork and aligning the artwork and the electrically conductive panel using the first set of tooling holes.

A further additional embodiment again includes an X-ray light source, an X-ray detector configured to generate an output indicative of the regions of the detector on which light is incident, and a processor connected to the X-ray detector and configured to identify a circular pattern using the output of the X-ray detector.

Another additional embodiment again includes drilling clearance holes in an electrically conductive panel of material, routing channels in the electrically conductive panels of material, laminating the electrically conductive panels with other panels of material to form an array of printed wiring board sub-assemblies, drilling through holes through each of the printed wiring boards in the array of printed wiring board subassemblies, plating the linings of the through holes and testing each printed wiring board in the array of printed wiring boards.

In another further embodiment, the channels are routed in locations that electrically isolate each printed wiring board from the other printed wiring boards in the array of printed wiring boards.

### BRIEF DESCRIPTION OF THE DRAWINGS

FIG. 1 is a flow chart showing a process for producing a printed wiring board including an electrically conductive constraining core in accordance with an embodiment of the present invention.

FIG. 2 is a flow chart showing a process for manufacturing a printed wiring board including an electrically conductive constraining core in accordance with an embodiment of the present invention.

FIG. 3 is a process for aligning a panel of material and drilling or punching tooling holes in the panel in accordance with an embodiment of the present invention.

FIG. 4A is an isotropic view of an aligned panel of material in which soft tooling holes have been punched in accordance with an embodiment of the present invention.

FIG. 4B is an isotropic view of a stack of drilled panels pinned to a work bench using mounting pins in accordance with an embodiment of the present invention.

FIG. 5A is an isotropic view of a stack of aligned panels in which hard tooling holes have been drilled in accordance with an embodiment of the present invention.

FIG. 5B is an isotropic view of a stack of drilled panels secured to a work bench using mounting pins in accordance with an embodiment of the present invention.

FIG. 6A is an isotropic view of a panel of material in accordance with an embodiment of the present invention.

FIG. 6B is an isotropic view of a stack of aligned panels of material that have been drilled with tooling holes in accordance with an embodiment of the present invention.

FIG. 6C is an isotropic view of a stack of panels of material secured to a work bench using pins in accordance with an embodiment of the present invention.

FIG. 6D is an isotropic view of a stack of panels of material secured to a work bench using pins and in which clearance holes and tooling holes have been drilled in accordance with an embodiment of the present invention.

FIG. 7A is an isotropic view of a stack of drilled panels of material secured to a work bench using pins and in which registration targets have been drilled in accordance with an embodiment of the present invention.

FIG. 7B is an isotropic view of an optical vision system locating reference holes in a drilled panel of material in accordance with an embodiment of the present invention.

FIG. 7C is a schematic cross-sectional view of an optical vision system locating a reference hole in accordance with an embodiment of the present invention.

FIG. 7D is an isotropic view of a drilled panel of material in which soft tooling holes have been punched using a tool including an optical vision system in accordance with an embodiment of the present invention.

FIG. 8 is a flow chart showing a process for creating and aligning artwork with a panel of material in accordance with an embodiment of the present invention.

FIG. 9 is a top view of a panel including hard tooling holes, reference holes and reference targets in accordance with an embodiment of the present invention.

FIG. 10 is a top view of a panel including soft tooling holes, reference holes and reference targets in accordance with an embodiment of the present invention.

FIG. 11 is a flow chart showing a process for constructing a printed wiring board subassembly in preparation for drilling vias in accordance with an embodiment of the present invention.

FIG. 12 is a flow chart showing a process for constructing a printed wiring board subassembly in preparation for drilling vias in accordance with a further embodiment of the present invention.

FIG. 13 is a flow chart showing a process for constructing a printed wiring board subassembly in preparation for drilling vias in accordance with another embodiment of the present invention.

FIG. 14 is a flow chart showing a process for constructing a printed wiring board subassembly in preparation for drilling vias in accordance with a still further embodiment of the present invention.

FIG. 15 is a top view of a panel including an array of printed wiring boards connected via tabs in accordance with an embodiment of the present invention.

FIG. 16 is a top view of a pane including an array of printed wiring boards separated by resin filled channels in accordance with an embodiment of the present invention.

FIG. 17 is a process in accordance with an embodiment of the present invention for modifying a panelized printed wiring board design to include resin filled channels to electrically isolate the printed wiring boards during testing in accordance with an embodiment of the present invention.

### DETAILED DESCRIPTION OF THE INVENTION

Turning now to the drawings, embodiments of processes for manufacturing printed wiring boards that include at least one electrically conductive constraining core in accordance with the present invention are shown. The processes include a variety of techniques that enable alignment of tools with respect to the layers of material being processed. Increasing alignment accuracy can reduce the likelihood of an unwanted electrical connection between a plated via and an electrically conductive constraining core. In many embodiments, alignment is achieved through the use of registration targets. In a number of embodiments, production throughput is increased using panelization. In embodiments where panelization is utilized, testing can be used during manufacture to detect faulty boards. In many embodiments, resin filled channels are included in a panel to electrically isolate each of the printed wiring boards during testing.

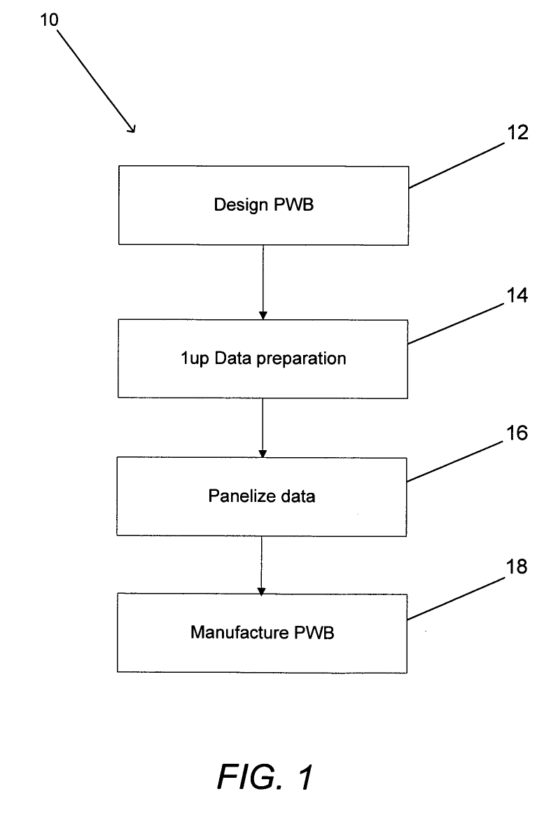

An embodiment of a process for manufacturing a printed wiring board in accordance with the present invention is shown in FIG. 1. The process 10 includes formulating (12) an initial printed wiring board design. The board design is then modified (14) to account for the fact that the printed wiring board includes at least one electrically conductive constraining core. The modified printed wiring board is then panelized (16) in preparation for manufacture. The panelized design is then used to create art work and export information to manufacturing equipment enabling the manufacture (18) of at least one printed wiring board.

A printed wiring board design typically specifies the circuits on each layer of the printed wiring board, identifies power, ground and/or split planes and indicates the locations of plated vias that connect the layers of the printed wiring board. A printed wiring board design can be created in any number of ways. In many embodiments of the process shown in FIG. 1, an initial printed wiring board design is created (12) that ignores the presence of electrically conductive constraining cores within the printed wiring board. The initial printed wiring board design may be expressed as a Gerber file. The Gerber file can then be modified (14) to account for the use of electrically conductive constraining cores within the printed wiring board. As discussed above, a plated via will create and electrical connection with an electrically conductive constraining core unless measures are taken to prevent such a connection. Techniques for modifying Gerber data to reduce the likelihood of an unwanted electrical connection between a plated via and an electrically conductive constraining core are disclosed in U.S. patent application Ser. No. 11/131,130 to Vasoya, which was filed May 16, 2005. The disclosure of U.S. patent application Ser. No. 11/131,130 is herein incorporated by reference in its entirety.

The modified Gerber data can then be panelized (16). Panelization is also described in U.S. patent application Ser. No. 11/131,130. Panelization is a process that can be used when manufacturing multiple printed wiring boards simultaneously and typically involves copying the drill data, pre-fab data and artwork for the printed wiring board design multiple times to create a panel from which an array of printed wiring boards can be constructed. As discussed in U.S. patent application Ser. No. 11/131,130, scaling factors are commonly applied to the artwork, drill data and prefab data associated with each panelized layer of a printed wiring board design in order to accommodate the expansion or contraction of the layer during manufacture of the printed wiring board. As will be discussed further below, manufacturing yields can be increased in accordance with embodiments of the present invention by including information in the Gerber file for the panelized printed wiring board that defines registration targets.

Once panelization is complete the scaled Gerber file including registration targets can be used to output artwork to pattern layers and configure computer controlled machines that can be used to perform tasks such as drawing wires, drilling holes, milling and cutting the panels. The artwork and configured manufacturing machines are then used to manufacture (18) printed wiring boards.

As will be discussed further below, the registration targets added to a panelized design and the manufacturing process used to manufacture a printed wiring board in accordance with the present invention typically depend upon the tools that are intended to be used during manufacture and the alignment techniques employed by those tools. Different tools can use different mounting pin configurations. Some tools use soft tooling. Soft tooling is the provision of slots that enable limited freedom of movement for materials to expand and contract along main axes of the panel. Other tools use hard tooling, which involves providing tooling holes that do not allow freedom of material movement.

Irrespective of the type of tooling, accurate placement of tooling holes is an important part of the manufacturing process. Tooling hole placement determines whether the work performed by a tool is aligned with the work performed by previous tools. As a panel is processed the panel can expand and contract. Therefore, placement of the tooling holes on the panel should account for any expansion or contraction. In embodiments where all of the tooling holes used during a manufacturing process are not created by the same tool, registration targets can be created to enable other tools to align themselves with respect to the panel. Once aligned, additional tooling holes can be created as required.

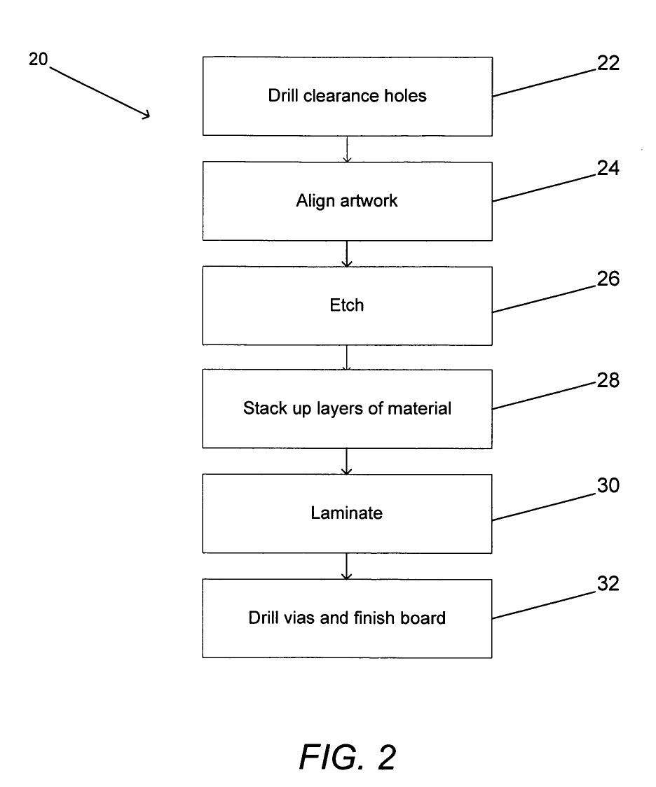

A generalized process for manufacturing a printed wiring board in accordance with an embodiment of the present invention is shown in FIG. 2. The process 20 includes drilling or punching (22) tooling holes through the electrically conductive constraining core. Clearance holes are then drilled (24) through the electrically conductive constraining core. In embodiments where the electrically conductive constraining core is clad on one or both sides with a metal such as copper, then artwork is aligned (26) relative to the electrically conductive constraining core and debris are etched (28) away. In embodiments where the electrically conductive constraining core does not include cladding, high pressure liquid or air can be used to clean machined debris.

Following etching, the electrically conductive constraining core can be combined with other layers of material to form a printed wiring board. A stack up including each of the layers of material that will form the printed wiring board is formed (64). The stack up is laminated (66). When the lamination is complete, vias can be drilled and plated and the printed wiring board finished (68) and tested.

As discussed above, any variety of tools can be used to perform the operations outlined in FIG. 2 for manufacturing a printed wiring board in accordance with embodiments of the present invention. Typically, tooling holes are required for the clearance hole drilling, the lamination and the post-lamination drilling of vias. The following discusses techniques for forming tooling holes required during each of these manufacturing steps.

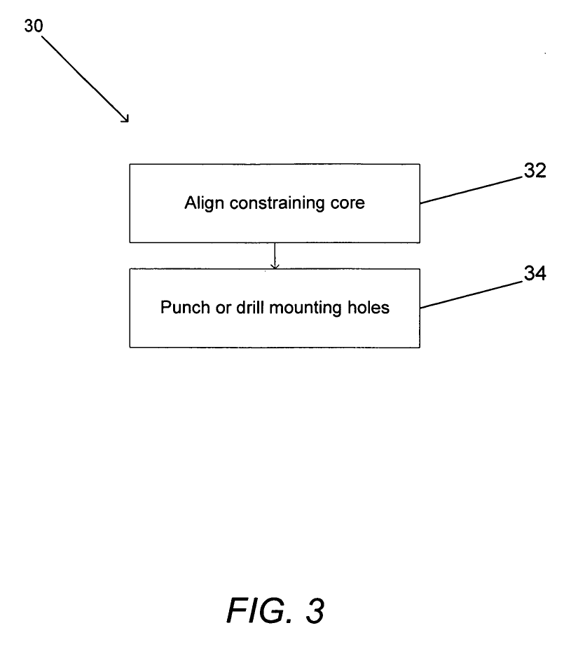

A process for creating an initial set of tooling holes for use during clearance hole drilling is shown in FIG. 3. The process 30 includes aligning (32) the panel from with the electrically conductive constraining core is created and then punching or drilling (34) tooling holes.

When using panels of woven fibrous material to construct the electrically conductive constraining cores within a printed wiring board, the behavior of the material during lamination can be impacted by the weave of the material. The placement of lamination tooling holes with respect to the weave of the carbon fiber can impact on whether the panel of material will warp (i.e., become non-planar) during lamination. Panels of woven material suitable for use as electrically conductive constraining cores are typically purchased in rectangular sheets, where the weave of the material aligns with the edges of the panel. In embodiments where such panels are used to construct electrically conductive constraining cores, the location of the mounting holes with respect to the weave can be determined by aligning the mounting holes relative to the edges of the sheet.

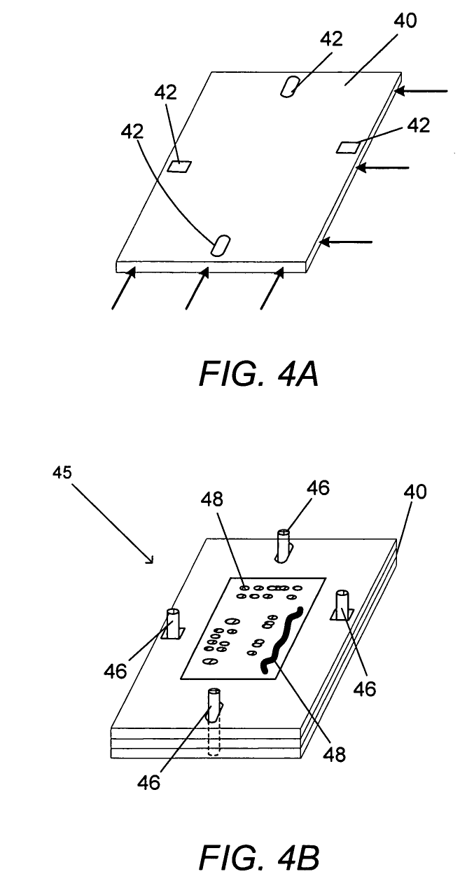

During manufacture, alignment can be simply achieved by establishing a work space with two reference edges oriented at right angles. Forcing the panel of woven fibers against the reference edges and securing the panel using tape can align the fiber with respect to a drill or punching tool. The alignment, punching and drilling of layers of material during the construction of electrically conductive constraining cores in accordance with an embodiment of the present invention is shown in FIGS. 4A and 4B. In the embodiment illustrated in FIG. 4A, the panel 40 includes soft tooling holes 42 that have been punched at the midpoint along each edge to achieve alignment with respect to the weave of the panel.

Production throughput can be increased by aligning, punching and drilling multiple electrically conductive constraining cores simultaneously. A stack of panels pinned to a work bench for clearance hole drilling in accordance with an embodiment of the present invention is shown in FIG. 4B. The stack 45 is secured by mounting pins 46 that extend through the mounting holes 44. A number of clearance holes 48 are drilled through each of the panels in the stack. In the illustrated embodiment, a single electrically conductive constraining core is manufactured per panel. As discussed above, other embodiments panelize the electrically conductive constraining core design so that an array of electrically conductive constraining cores can be constructed using a single panel of material.

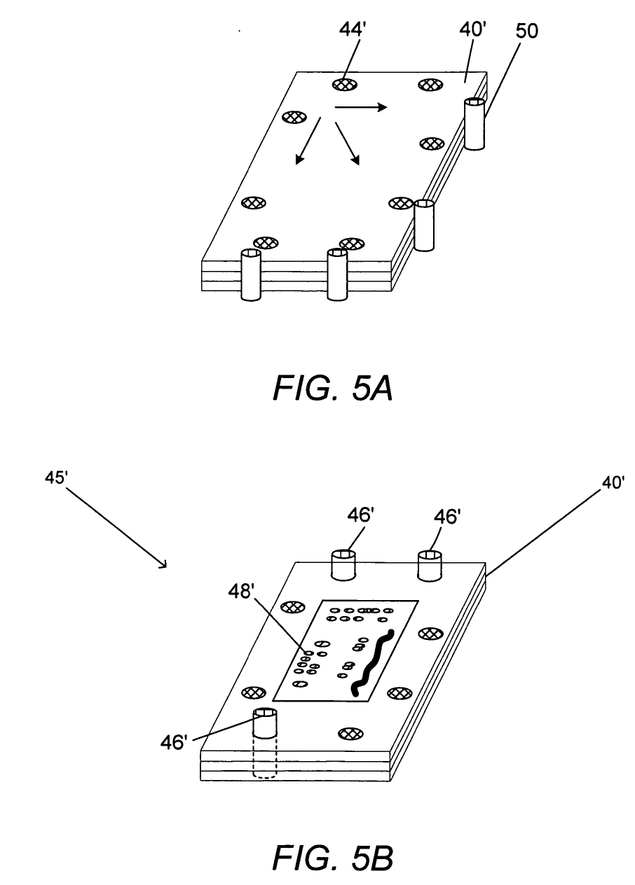

The embodiments shown in FIGS. 4A and 4B use the same soft tooling holes during clearance hole drilling and lamination. Embodiments in accordance with the present invention can use hard tooling holes during clearance hole drilling and lamination. Alignment and drilling of tooling holes and clearance holes in panels of material in accordance with an embodiment of the present invention are shown in FIGS. 5A and 5B. The alignment of a stack of panels against alignment pins is shown in FIG. 5A. Panels of material 40′ are formed into a stack 45′ and the edges of the panels are forced against alignment pins 50 to obtain alignment. Once alignment has been achieved, lamination tooling holes 44′ are drilled through the stack 45′ of panels 40′.

A stack of panels secured to a work bench using pins for clearance hole drilling is shown in FIG. 5B. Pins 46′ extending through several of the lamination tooling holes 44′ are used to secure the stack 45′ of panels 40′ of material to a work bench. Thus secured, clearance hole drilling can be performed. In the illustrated embodiment, clearance holes 48′ are shown drilled through each panel 40′ in the stack 45′.

The embodiments shown in FIGS. 4A, 4B, 5A and 5C use the lamination tooling holes during clearance hole drilling. In many embodiments, separate sets of tooling holes are used for clearance hole drilling and for lamination. When separate sets of tooling holes are used, care must be taken to ensure that the position of the tooling holes ensures alignment between the processes performed by each tool.

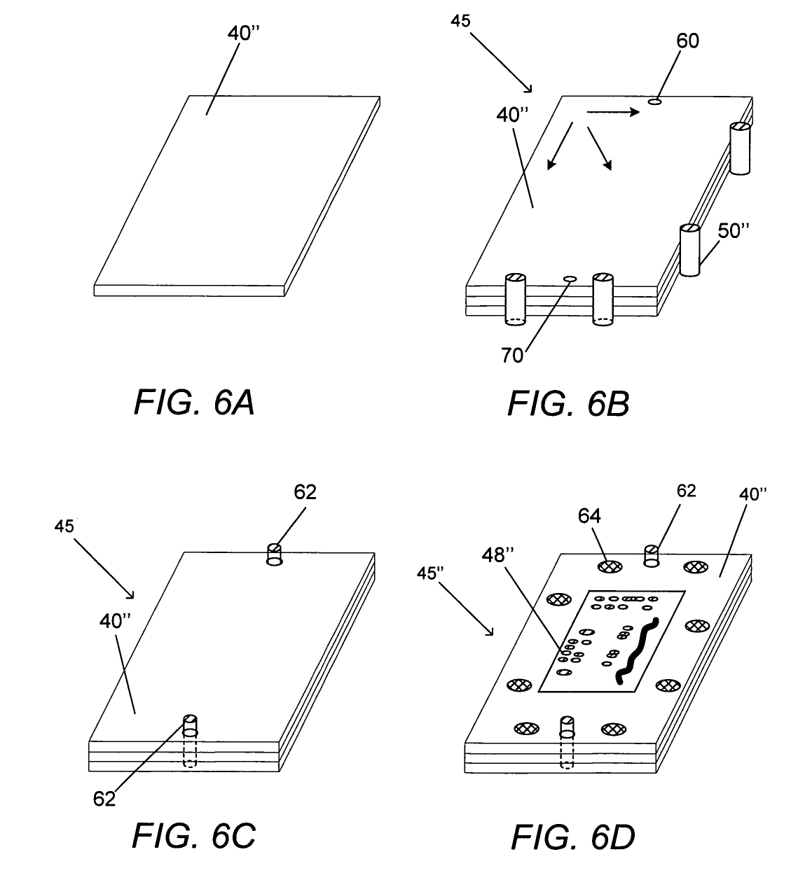

Panels of material in which the tooling holes used for clearance hole drilling are used as references for drilling lamination tooling holes in accordance with an embodiment of the present invention are shown in FIGS. 6A-6D. A panel of material is shown in FIG. 6A. A stack 45″ of panels 40″ is shown being forced against alignment pins 50″. Forcing the panels against the pins provides alignment for drilling a first set of tooling holes 60 for use during clearance hole drilling. The stack 45″ of panels 40″ secured to a work bench using pins 62 in accordance with an embodiment of the invention is shown in FIG. 6C. Once the stack 45″ is secured, the pins 62 form a reference that can be used to drill clearance holes and lamination tooling holes. A stack of panels secured to a work bench that has been drilled in accordance with an embodiment of the present invention is shown in FIG. 6D. Clearance holes 48″ have been drilled through each panel 40″ in the stack 45″. In addition, lamination tooling holes 64 have been drilled through the panels 40″. The lamination tooling holes shown in the illustrated embodiment are hard tooling holes.

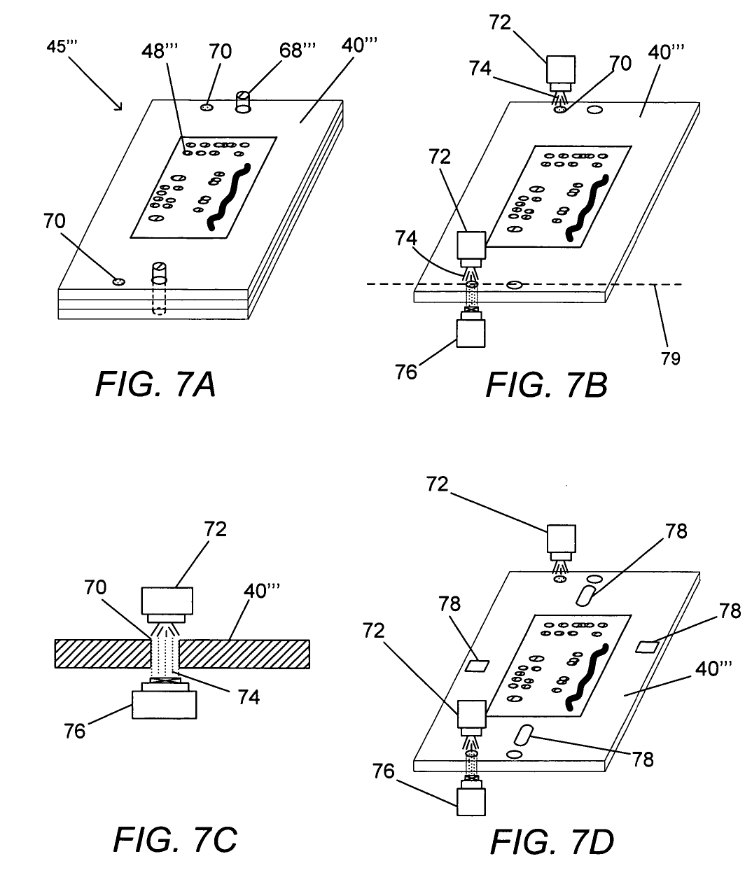

Panels of material in which clearance holes have been drilled and reference holes are used to align a tool for punching soft lamination tooling holes are shown in FIGS. 7A-7D. A stack 45′″ of panels 40′ secured to a work bench via pins 62′″ and in which clearance holes 48′41 and reference holes 70 have been drilled in accordance with an embodiment of the present invention is shown in FIG. 7A. An optical vision system locating a reference hole in accordance with an embodiment of the present invention is shown in FIG. 7B. Two optical vision systems are used to locate the reference holes 72 in the panel 40′″. Each optical vision system includes a light source 72 that shines light (or another form of electromagnetic radiation). A light detector 76 is positioned below the panel. The optical reference system searches for the reference hole in a predetermined area. The manner in which the area can be defined can include definition relative to the clearance hole tooling holes or definition relative to the edges of the panel. The reference holes are deemed located when the light detector detects a complete circle of light.

A cross section taken along the ghost line 79 in FIG. 7B showing the optical vision system locating a reference hole in accordance with an embodiment of the present invention is shown in FIG. 7C. The reference hole 70 is located at the point in which the light source 72 completely illuminates the reference hole. The complete illumination of the reference hole 70 is detected as a complete circle of light by the light detector 76. The optical vision system illustrated in FIG. 7B differs from the optical vision systems typically used in the construction of a printed wiring board in that the optical vision system attempts to locate a reference that is a circle of light. Tooling systems that include optical vision can be obtained from Multiline Technology of Farmingdale, N.Y. The dielectric materials used to construct printed wiring boards that do not include electrically conductive constraining cores are typically transparent. Therefore, registration targets are typically patterned as circular regions of copper. The circular regions of copper appear as dark circles and, therefore, optical vision system search for dark circles (instead of circles of light as in the present invention).

Once the reference holes have been located, the reference holes can be used to punch lamination tooling holes. Soft tooling holes punched in a panel using reference holes located using an optical vision system in accordance with the present invention are shown in FIG. 7D. The panel 40′″ includes soft tooling holes 78 that have been punched at the midpoint along each edge of the panel.

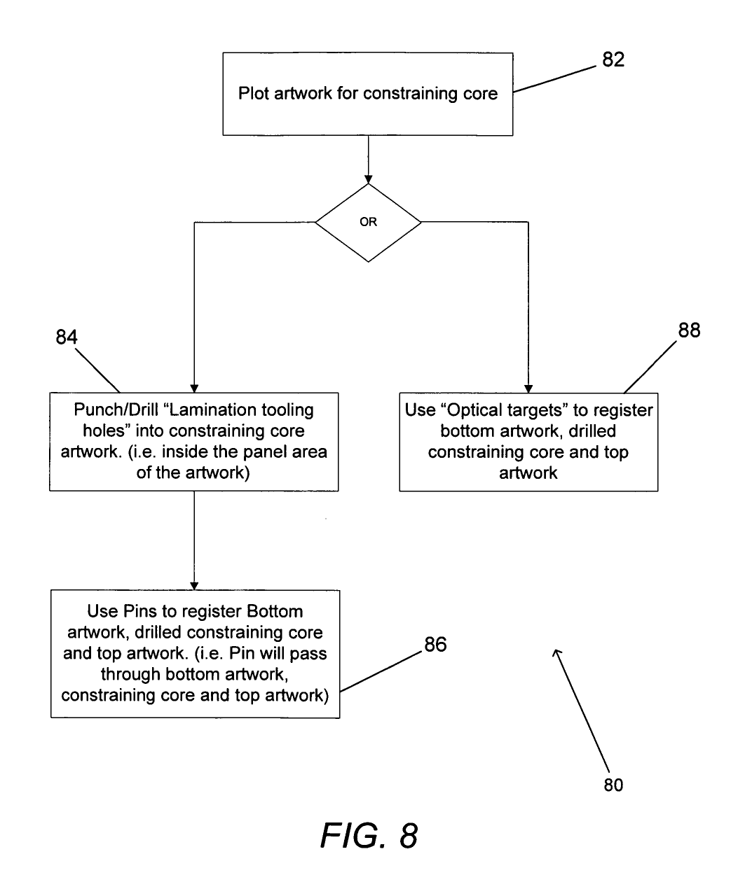

Referring back to the process shown in FIG. 2, an etching process typically follows clearance hole drilling for panels that are clad with layers of metal. The regions that are etched can be controlled by screening photoresist over the cladding material and selectively exposing the photoresist using artwork. During etching, chemicals etch the cladding material that has been selectively exposed by the artwork. A process for producing artwork in accordance with the present invention and aligning the artwork relative to a drilled electrically conductive constraining core is shown in FIG. 8. The process 80 includes plotting (82) the artwork for the constraining core. The artwork can be aligned in one of two ways. In many embodiments, artwork is aligned by punching or drilling (84) tooling holes into the artwork that correspond to tooling holes in the electrically conductive constraining core. Passing (86) pins through the tooling holes can then be used to align the bottom artwork, the drilled electrically conductive constraining core and the top artwork. In other embodiments, optical targets can be used to align (88) the top and bottom artwork with the drilled electrically conductive constraining core. The optical target method typically involves the use of a top and a bottom camera to align targets on the artwork with predrilled tooling holes on the electrically conductive constraining core.

The optical target method of aligning artwork can be less precise than the using tooling holes. Therefore, in embodiments where reference holes and targets are used to perform drilling or punching of post-lamination tooling holes, then aligning artwork using tooling holes can be preferable.

Referring again to the process shown in FIG. 2, the drilling of vias is typically performed following lamination. In several embodiments, the lamination tooling holes are used as the tooling holes for performing via drilling. In other embodiments, the reference targets are used to drill or punch post-lamination tooling holes for via drilling.

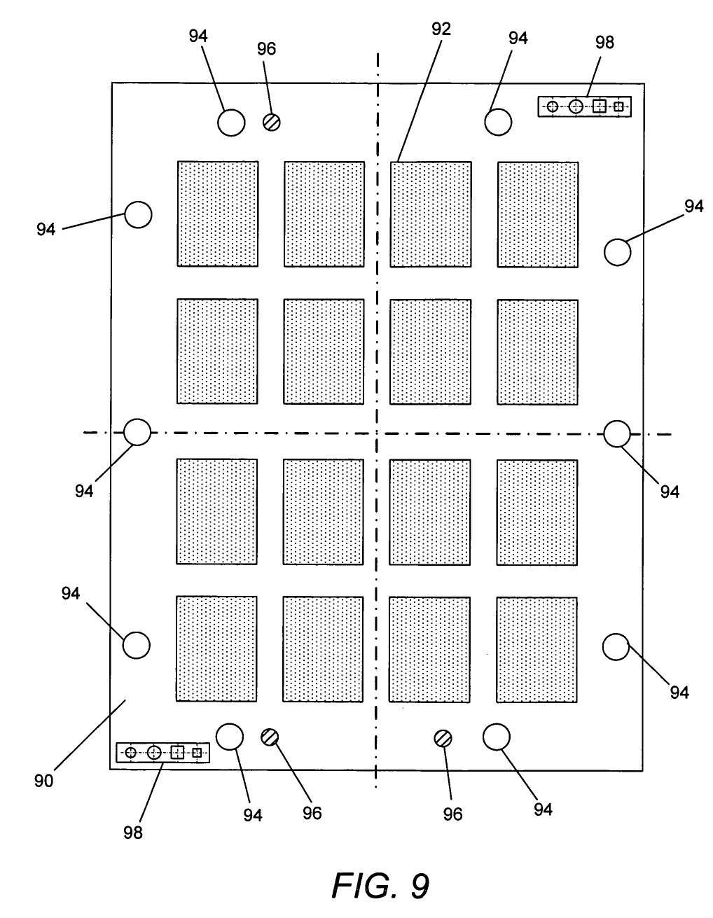

An embodiment of a panel in accordance with the present invention that includes an array of printed wiring board subassemblies, a number of tooling holes, a number of reference holes and registration verification targets in accordance with an embodiment of the present invention is shown in FIG. 9. The panel 90 includes an array of printed wiring board subassemblies 92. Each subassembly is constructed from a number of layers of material including at least one electrically conductive constraining core. The panel also includes a plurality of lamination tooling holes 94. In addition to the lamination tooling holes, the panel includes a number of reference holes 96 and registration verification targets 98 that can be used as reference to locate the appropriate position to drill or punch post-lamination tooling holes (i.e., the post-lamination tooling holes are defined in predetermined locations relative to the references). The post-lamination tooling holes can then be used to perform via drilling. In the embodiment illustrated in FIG. 9, the lamination tooling holes are hard tooling holes.

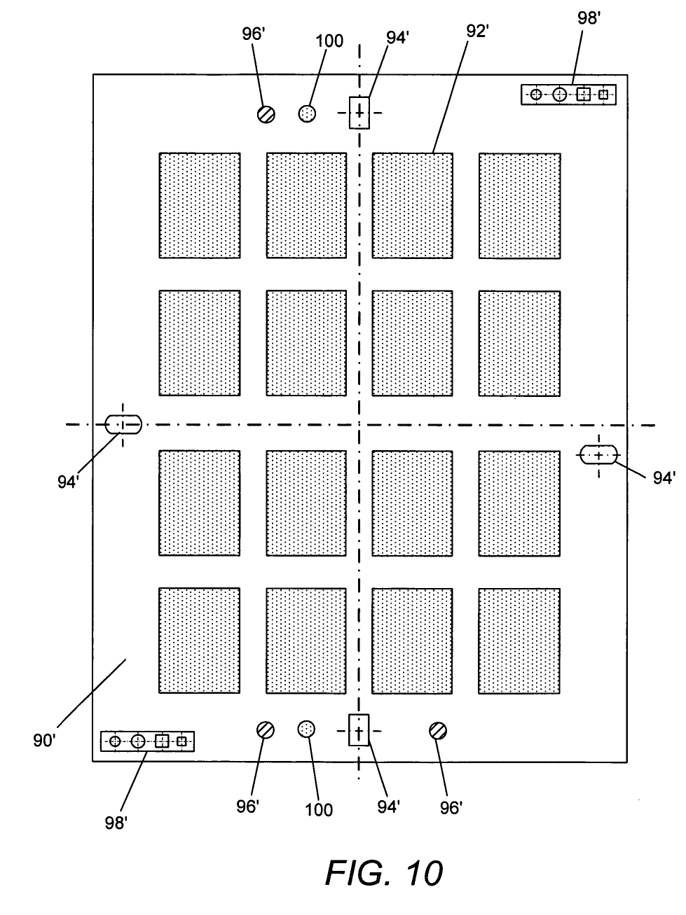

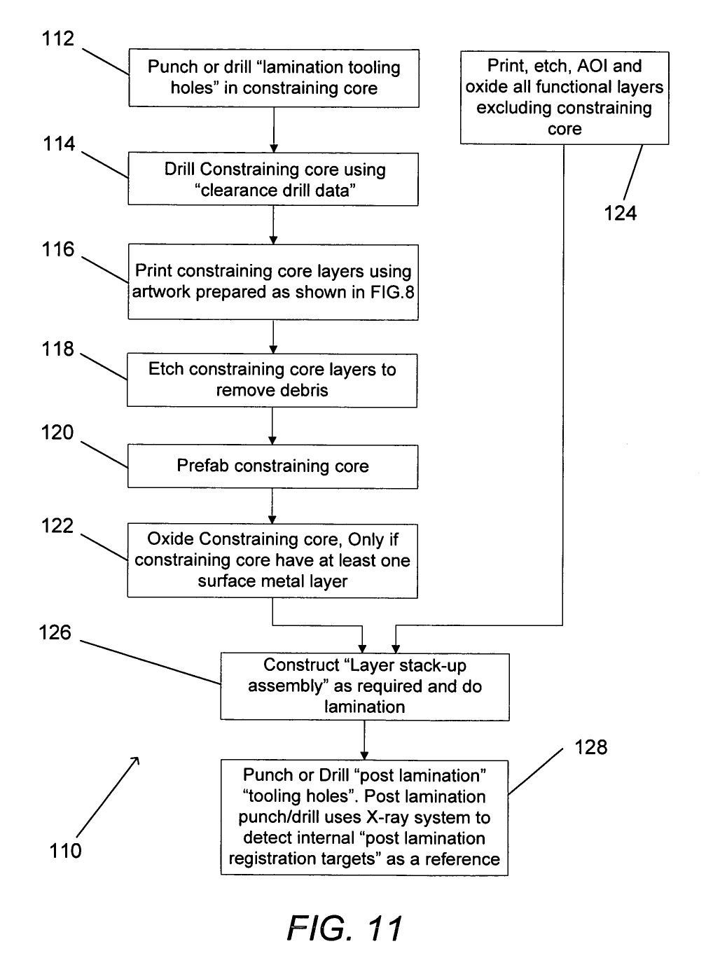

A panel including an array of printed wiring board subassemblies, a number of tooling holes, a number of registration holes, a number of registration verification targets and a number of registration target holes in accordance with the present invention is shown in FIG. 10. The panel 90′ shown in FIG. 10 is similar to the panel 90 shown in FIG. 9 with the exceptions that the tooling holes 94′ in FIG. 10 are soft tooling holes and the panel 90′ in FIG. 10 also includes registration target holes 100. The registration target holes 100 are used as a reference to punch tooling holes 94′.

The above discussion outlines a variety of different techniques for creating tooling holes at various stages in the manufacture of a printed wiring board in accordance with embodiments of the present invention. These techniques can be combined in a variety of ways to provide the necessary tooling holes for performing clearance hole drilling, artwork alignment, lamination and via drilling. Several combinations are discussed below.

A process for forming tooling holes where lamination tooling holes are used for clearance hole drilling and lamination and post-lamination tooling holes are punched or drilled using post-lamination registration targets in accordance with an embodiment of the present invention is shown in FIG. 11. The process 110 includes punching or drilling (112) lamination tooling holes in a panel and then drilling (114) clearance holes in the panel. Assuming the panels are clad, the panels are printed (116) using artwork and then etched (118) to remove debris. A prefab process is performed (120) and then the panels of material are oxided (122). In preparation for lamination, the other layers of material used in the construction of the printed wiring board (i.e., the layers that do not form electrically conductive constraining cores) are processed (124). The panels of material used to construct the electrically conductive constraining cores and the other layers of material are then stacked and laminated (126). Following lamination, post-lamination tooling holes are punched or drilled (128) in the arrays of printed wiring board subassemblies formed during lamination. The post-lamination tooling holes are formed in preparation for via drilling and finishing of the printed wiring boards. In many embodiments, the post-lamination tooling holes are positioned using an X-ray system that detects internal post-lamination registration targets as references.

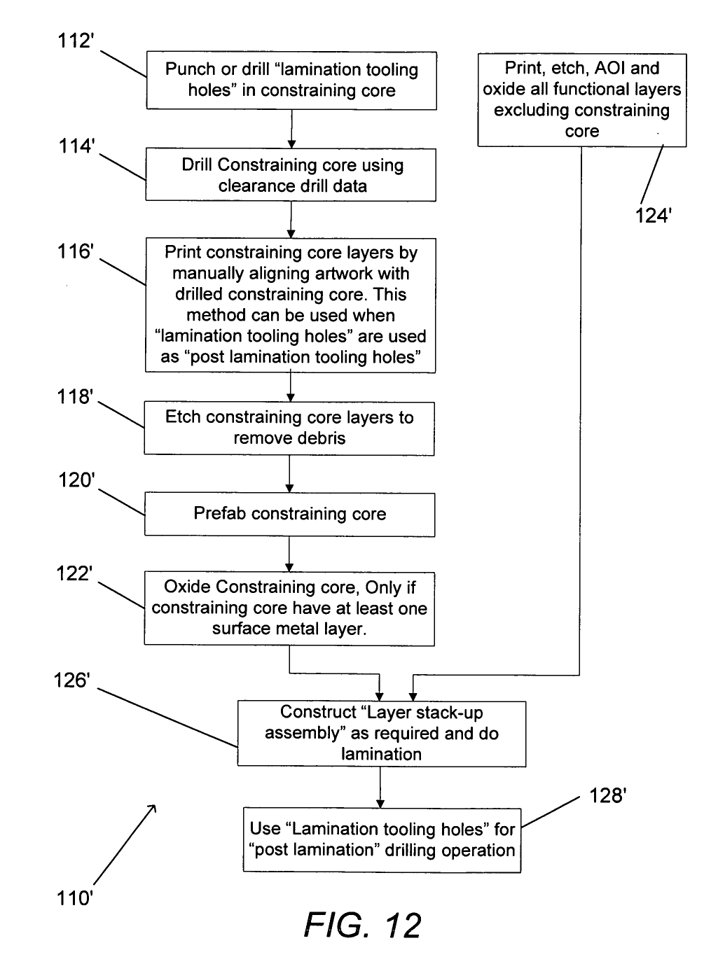

A process for forming tooling holes where lamination tooling holes are used for clearance hole drilling, lamination and post-lamination via drilling in accordance with an embodiment of the present invention is shown in FIG. 12. The process is similar to the process shown in FIG. 11 with the exceptions that optical registration 116′ can be used to align artwork and the lamination tooling holes are used for performing post-lamination via drilling.

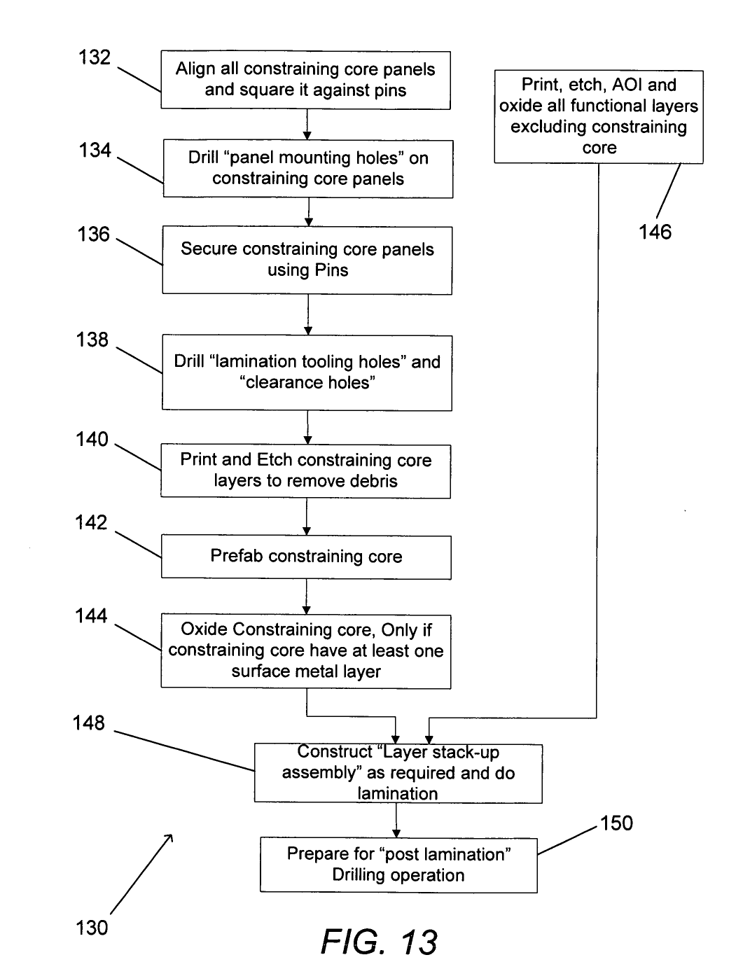

A process for forming tooling holes where a first set of tooling holes is used for clearance hole drilling, separate lamination tooling holes are used during lamination and the lamination tooling holes are used for post-lamination via drilling in accordance with an embodiment of the present invention is shown in FIG. 13. The process 130 includes aligning (132) the panels of material and drilling (134) panel mounting holes through the panel. The panels are secured (136) against the work bench using pins to enable the drilling (138) of clearance holes and lamination tooling holes. Following drilling, the panels are printed and etched to remove debris and a prefab process is performed (142) on each panel. If the panels are clad, then the panels can also be oxided (144). Prior to lamination (148) the panels of material are combined with other layers of material that have been processed (146) for inclusion in a stack up. Following lamination, the post-lamination drilling operation can be performed (150) using the lamination tooling holes as a reference.

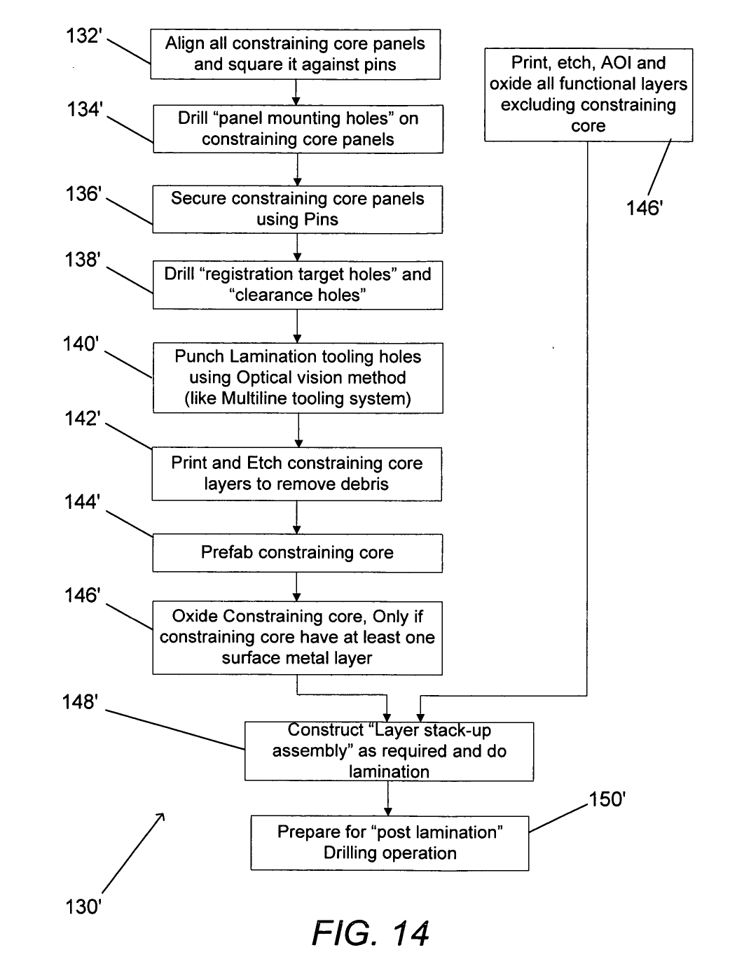

A process for forming tooling holes where a first set of tooling holes are used for clearance hole drilling, separate lamination tooling holes are punched for use during lamination and the lamination tooling holes are used for post-lamination via drilling in accordance with an embodiment of the present invention is shown in FIG. 14. The process 130′ is similar to the process 130 shown in FIG. 13 with the exception that registration target holes are drilled (138′) in the panels and the registration target holes are used to punch (140′) lamination tooling holes in the panel using tools that are equipped with optical vision systems which are capable of locating the registration target holes in accordance with embodiments of the present invention.

The processes discussed above can be used to increase yield during the production of printed wiring boards. In many embodiments of the present invention testing is used to verify that a printed wiring board has been manufactured correctly or to identify a faulty printed wiring board. In many embodiments, electrical testing of printed wiring boards is performed to identify printed wiring boards that include faults such as short circuits between an electrically conductive constraining core and a plated via. When panelization is used to manufacture arrays of printed wiring boards from panels of material, the ability to simultaneously test each printed wiring board in the array can increase testing efficiency. Electrical connections between the electrically conductive constraining cores in each printed wiring board in a panelized design can cause a fault in one printed wiring board to result in the detection of a fault in all of the printed wiring boards. The ability to identify a faulty printed wiring board in an array of printed wiring boards can be achieved in accordance with many embodiments of the present invention by electrically isolating each printed wiring board in the array. In many embodiments, electrical isolation is achieved by including routed channels in the electrically conductive constraining core design and etching the layers of metal in the printed wiring board design away from the points at with adjacent printed wiring boards in an array contact. During lamination the resin filled channels fill with resin. The effect of the resin filled channels and etched back metal layers is to create electrical isolation at the points where the printed wiring boards in the array physically contact each other.

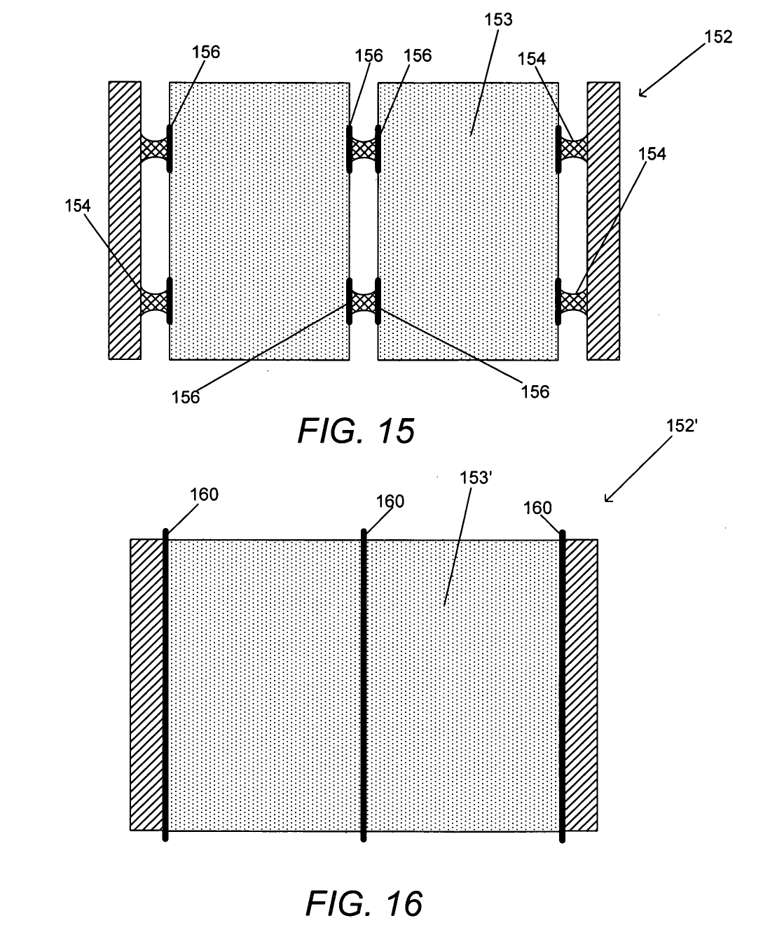

A panel including an array of printed wiring boards that are electrically isolated from each other in accordance with an embodiment of the invention is shown in FIG. 15. The panel 152 includes a number of printed wiring boards 153 connected in an array via tabs 154. The tabs 154 do not form an electrical connection between the printed wiring boards 153 in the array, because the electrically conductive layers in the tabs are separated from the electrically conductive layers within the adjacent printed wiring boards by the resin filled channels 156.

Another embodiment of a panel having an array of printed wiring boards that are electrically isolated from each other in accordance with an embodiment of the invention is shown in FIG. 16. The panel 152′ includes a number of printed wiring boards 153′ in array that are electrically isolated from each other via resin filled channels 160 that extend along the entire lengths of the edges of the printed wiring boards.

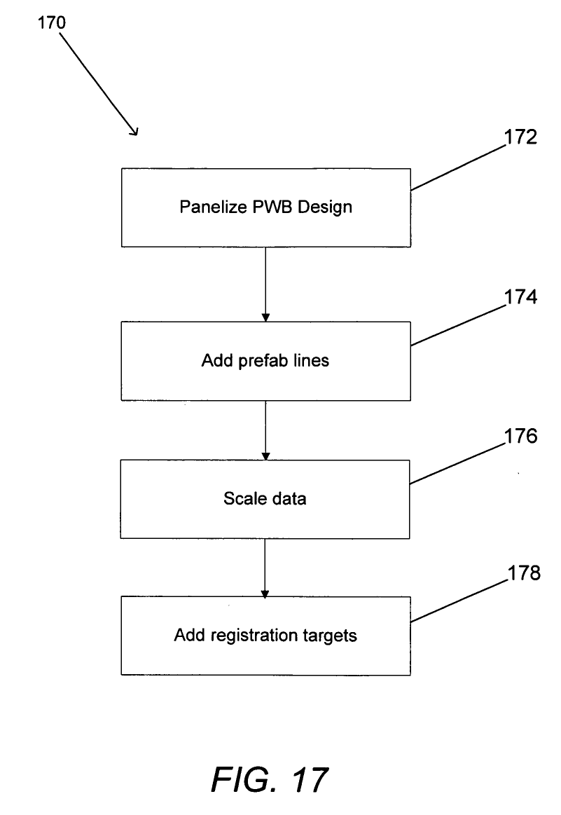

The creation of resin filled channels and etching back of metal layers to achieve electrical isolation requires modification of Gerber data during panelization. An embodiment of a process in accordance with the present invention that can be used to modify a Gerber file to panelize a printed wiring board design in a way that enables the construction of an array of printed wiring boards that are electrically isolated from each other in accordance with an embodiment of the present invention is shown in FIG. 17. The process 170 includes panelizing (172) the Gerber data associated with the printed wiring board design. Additional routed channels can then be added (174) to the layers defined in the Gerber file that are to be constructed from carbon. The routed channels are defined in locations that enable the construction of an array of printed wiring boards, where each printed wiring board in the array is electrically isolated. The nature of the routed channels can depend upon whether the printed wiring boards separated by tabs in the panelized design. Following the addition of routed channels to the Gerber file, relevant portions of the Gerber file can be scaled (176) and information defining registration targets can be added (178) to the Gerber file.

While the above description contains many specific embodiments of the invention, these should not be construed as limitations on the scope of the invention, but rather as an example of one embodiment thereof. For example, although much of the above discussion assumes panelization of the printed wiring board design in order to increase production volume, a single panel can be used to manufacture a single printed wiring board in accordance with embodiments of the present invention. When a single board is manufactured per panel, the Gerber file can be modified by scaling the printed wiring board design to account for expansion and contraction during manufacture and to include registration targets on the panel with the aim of increasing production yields. Accordingly, the scope of the invention should be determined not by the embodiments illustrated, but by the appended claims and their equivalents.

What is claimed is:

1. A process for manufacturing a printed wiring board, comprising:
aligning the weave of a woven panel of electrically conductive material relative to a tool surface using at least a pair of references; and
forming tooling holes in the panel of electrically conductive material.

2. The process of claim 1, wherein the pair of references include:
at least two mounting pins positioned along a first line;
at least two mounting pins positioned along a second line; and
wherein the first and second lines intersect at a right angle.

3. The process of claim 1, wherein the pair of references include:
a first reference edge; and
a second reference edge;
wherein the first and second reference edges meet at a right angle.

4. The process of claim 1, wherein the tooling holes are formed using a drill.

5. The process of claim 1, wherein the tooling holes are formed using a punch.

6. A process for manufacturing a printed wiring board comprising:
forming a first set of tooling holes in a panel of electrically conductive material;
drilling clearance holes having a first diameter in the electrically conductive panel;
forming a stack of panels by aligning the panel of electrically conductive material with other layers of material using the first set of tooling holes; and
laminating the stack of panels.

7. The process of claim 7, further comprising drilling through holes having a second diameter less than the first diameter through the laminated stack.

8. The process of claim 8, further comprising using the first set of tooling holes as a reference to determine the locations in which to drill the through holes.

9. The process of claim 8, further comprising:
drilling at least one reference hole;
using an optical vision system to locate the at least one reference hole; and
drilling a second set of tooling holes in predetermined locations relative to the at least one reference hole.

10. The process of claim 8, further comprising:
drilling at least one reference hole;
using an optical vision system to locate the at least one reference hole; and
punching a second set of tooling holes in predetermined locations relative to the at least one reference hole.

11. The process of claim 8, further comprising:
aligning artwork against the electrically conductive panel;
screening photoresist over the artwork; and
etching the electrically conductive panel.

12. The process of claim 8, wherein aligning the artwork comprises:
punching holes corresponding to the first set of tooling holes in the artwork; and
aligning the artwork and the electrically conductive panel using the first set of tooling holes.

13. A process for manufacturing a printed wiring board comprising:
forming a first set of tooling holes in a panel of electrically conductive material;
drilling clearance holes having a first diameter in the electrically conductive panel;
forming a second set of tooling holes through the panel of electrically conductive material;
forming a stack of panels by aligning the panel of electrically conductive material with other layers of material using the second set of tooling holes; and
laminating the stack of panels.

14. The process of claim 13, wherein the forming of a second set of tooling holes further comprises:
using the first set of tooling holes as a reference to locate predetermined locations; and
drilling the second set of tooling holes at the predetermined locations.

15. The process of claim 13, wherein the forming of a second set of tooling holes further comprises:
using the first set of holes as a reference to locate at least one predetermined location;
drilling a reference hole in the at least one predetermined location;
using an optical vision system to locate the reference hole; and
using the optical vision system to punch the second set of tooling holes in predetermined locations relative to the reference hole.

16. The process of claim 13, further comprising drilling through holes having a second diameter less than the first diameter through the laminated stack.

17. The process of claim 13, further comprising using either the first or the second set of tooling holes as a reference to determine the locations in which to drill the through holes.

18. The process of claim 13, further comprising:
drilling at least one reference hole;
using an optical vision system to locate the at least one reference hole; and
drilling a second set of tooling holes in predetermined locations relative to the at least one reference hole.

19. The process of claim 13, further comprising:
drilling at least one reference hole;
using an optical vision system to locate the at least one reference hole; and
punching a second set of tooling holes in predetermined locations relative to the at least one reference hole.

20. The process of claim 13, further comprising:
aligning artwork against the electrically conductive panel;
screening photoresist over the artwork; and
etching the electrically conductive panel.

21. The process of claim 20, wherein aligning the artwork comprises:
punching holes corresponding to the first set of tooling holes in the artwork; and
aligning the artwork and the electrically conductive panel using the first set of tooling holes.

22. An optical vision system, comprising:
an X-ray light source;
an X-ray detector configured to generate an output indicative of the regions of the detector on which light is incident; and
a processor connected to the X-ray detector and configured to identify a circular pattern using the output of the X-ray detector.

23. A process for manufacturing a printed wiring board, comprising:
drilling clearance holes in an electrically conductive panel of material;
routing channels in the electrically conductive panels of material laminating the electrically conductive panels with other panels of material to form an array of printed wiring board sub-assemblies;
drilling through holes through each of the printed wiring boards in the array of printed wiring board subassemblies;
plating the linings of the through holes; and
testing each printed wiring board in the array of printed wiring boards.

24. The process of claim 23, wherein the channels are routed in locations that electrically isolate each printed wiring board from the other printed wiring boards in the array of printed wiring boards.
